(19) United States
(12) Patent Application Publication
(10) Pub. No.: US 2017/0265687 A1
(43) Pub. Date: Sep. 21, 2017

(54) Location Based Holding

(71) Applicant: Prince Castle LLC, Carol Stream, IL (US)

(72) Inventors: Loren Veltrop, Chicago, IL (US); Brian Truesdale, Wauconda, IL (US); Jeremy J. Falkos, Batavia, IL (US); Scott R. Hammac, Joliet, IL (US); Scott Northuis, Otsego, MN (US); Eloy Cerda, Summit, IL (US); Angelo Fraboni, Minneapolis, MN (US)

(73) Assignee: Prince Castle LLC, Carol Stream, IL (US)

(21) Appl. No.: 15/462,210

(22) Filed: Mar. 17, 2017

Related U.S. Application Data
(60) Provisional application No. 62/309,713, filed on Mar. 17, 2016.

(51) Int. Cl. A47J 47/14; G05D 23/19; G05B 15/02; G08G 1/00

(52) U.S. Cl. CPC A47J 47/14; G08G 1/20; G05D 23/1917; G05B 15/02

(57) ABSTRACT

A location based holding system comprises a holding device. The holding device includes a food storage chamber and a temperature sensor. The temperature sensor senses the temperature of the food storage chamber. A temperature control device changes the temperature of the food storage chamber. A location device determines the physical location of the holding device. A memory stores information about a food item located in the food storage chamber. A processor is operatively coupled to the memory, location device, and holding device. The processor activates the temperature control device of the holding device based on the physical location of the food storage or transportation device.

### CROSS-REFERENCE TO RELATED APPLICATION

The present application claims priority of U.S. Provisional Patent Application No. 62/309,713, filed on Mar. 17, 2016, the content of which is hereby incorporated herein by reference in its entirety.

### FIELD OF THE DISCLOSURE

The present disclosure relates generally to food cooking and/or reheating systems and methods and more particularly to location based food cooking and/or reheating systems and methods.

### BACKGROUND

In many restaurant service settings, food is prepared in advance and held until it is delivered to the customer. In a typical fast food restaurant setting, since many restaurant customers expect to receive ordered food items quickly and often within less time than it takes to prepare the food items individually, food items are prepared ahead of actual orders and the food items are held in a condition to keep them ready for sale.

In delivery food services, often times food may be prepared after a customer places a specific order; however, the food must then be transported to the customer. The actual delivery of the food takes an indeterminate amount of time based upon, for example, traffic conditions, number and order of deliveries on a route, as well as, delivery person skill and efficiency.

Food is also often prepared in one location and delivered and/or served to a consumer at another location, whether the food is delivered and/or served to a consumer off the premises (such as a pizza delivery), delivered and/or served to a consumer in another room (such as a banquet hall), or delivered and/or served to a consumer in another part of the location at which the food is prepared for consumption by the consumer (such as at a purchase counter). In any event, the food may have a desired temperature at each physical location in the delivery process. For example, uncooked food may need to be kept refrigerated until shortly before cooking, for example, in a refrigerator or cooler. The food may then need to be cooked to a desired temperature at a cooking location. After cooking, the food may need to be kept at a temperature lower than the cooking temperature (sometimes called the stasis temperature) until just before delivery to a consumer to prevent overcooking and loss of palatability of the food. However, providing food to the consumer at the stasis temperature after cooking may not provide an optimal palatable experience for the consumer. Thus, the food may need to be reheated just before delivery to give the consumer an optimum dining experience.

In both restaurant and delivery settings, prepared food holding solutions have resorted to prolonging and slowing of the gradual degradation of prepared food quality over time. Recent advances in location identification technology, for example GPS and cellular or mobile signal triangulation, result in new available information that can be used to improve the characteristics of prepared food at a time of delivery to a customer.

Currently, if food needs to be reheated prior to delivery, the heating process must be manually started by an operator. As a result, the food may not have adequate time to warm up, the food may be warmed up too early, causing the food to restart the cooking process, or the rewarming process may be forgotten altogether.

An exemplary embodiment of a location based holding system including a holding device. The holding device includes a food storage chamber and a temperature sensor that senses a temperature of the food storage chamber. A temperature control device is operable to change the temperature of the food storage chamber. A location device determines the physical location of the holding device. A memory stores information about a food item located in the food storage chamber. A processor is operatively coupled to the memory, the location device, and the holding device. The processor activates the temperature control device of the holding device based on the physical location of the holding device.

An exemplary embodiment of a method of holding prepared food includes receiving cooked food within a compartment of a holding device. The holding device is operated to apply a first treatment which includes at least one of a first temperature and a first humidty. The treatment is temporally applied according to a holding profile. A value is received that is indicative of a time until delivery of the prepared food. The received value is monitored against the holding profile. Upon a predetermined time until delivery, the holding profile changes form a holding phase to a consumption phase. The holding device is operated to apply a second treatment according to the holding profile. The second treatment includes at least one of a second temperature and a second humidity.

A further exemplary embodiment of a location based holding system includes a holding device. The holding device includes a temperature sensor that senses a temperature about the holding device. The holding device includes a temperature controlled device operable to change a temperature of the holding device. A food container is operable to receive a cooked food to be held by the holding device. A location device determines the physical location of the holding device. A memory stores information about a food item located in the food container. A processor is operatively coupled to the memory, the location device, and the holding device. The processor activates the temperature control device of the holding device based on the physical location of the holding device.

### BRIEF DESCRIPTION OF THE DRAWINGS

FIG. 1 depicts an exemplary embodiment of a graph of a food treatment profile.

FIG. 2 is a plan view of food delivery with location based holding.

FIG. 3 is a system diagram that depicts an exemplary embodiment of a location based holding system.

FIG. 4 is a plan view of an exemplary embodiment of a food preparation area.

FIG. 5 depicts a method of location based holding.

FIG. 6 depicts an exemplary embodiment of a partitioned food holding cabinet.

FIG. 7 is a partial cut away view of an exemplary embodiment of a food container.

FIGS. 8A-E depict additional exemplary embodiments of food containers and holding devices.

### DETAILED DISCLOSURE

The location based food temperature system described below may incorporate food storage devices and/or modular food storage systems, such as those devices and systems described in U.S. Ser. No. 13/326,667 and U.S. Ser. No. 14/850,914, each of which are hereby incorporated by reference herein in their entireties.

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

As used herein, the term “location based food temperature system” is hereby defined to mean any system that is capable of holding food in a fully prepared state, which is ready for immediate sale, consumption, or use. The term “location based food temperature system” is further defined to mean any system that is capable of holding food in a partially prepared or intermediate state, which is ready for further preparation. The term “location based food temperature system” is further defined to include hot and cold food holding systems, which may include conventional heating and/or cooling elements, such as, for example, IR toaster elements, radiant heating elements, refrigeration coils, etc., or any other type of heating or cooling device.

As used herein, the term “change in temperature” also includes may be achieved by a change in a heating or cooling method. Different heating or cooling methods include, heating in an oven or heating in a broiler with combustion heating elements or electrical heating elements, toasting with electrical or IR heating elements, cooling or freezing with a cooling or refrigeration coil, or any other method of changing the temperature of a food item. Convection or other air circulation heating/cooling methods can carryout changes in temperature, but also other environmental conditions.

As used herein, the term “heat capacity” includes the amount of energy required to be added to (or removed from) a food item to change the temperature of the food item from a stasis temperature to an optimum consumption temperature. The term “heat capacity” also includes an amount of time that is needed to raise a food item from a stasis temperature to an optimum consumption temperature for a given temperature element (e.g., heating or cooling element).

Once food is cooked or otherwise prepared for consumption, the quality of the food for consumption begins to degrade over time. Current solutions in food holding technologies for holding previously prepared food focus on prolonging or slowing this degradation to increase an acceptable length of time from the time of food preparation to the time of customer delivery while keeping food within a range of acceptable qualities for consumption.

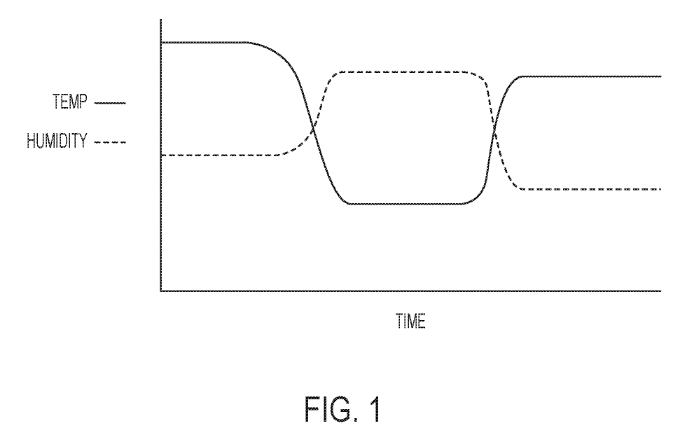

Rather, food treatment after cooking can be performed according to a treatment profile exemplarily as depicted in FIG. 1. FIG. 1 is intended to be general and exemplarily in nature and not necessarily representative or limiting on treatment profiles as may be used within the scope of the present disclosure. The treatment profile of FIG. 1 exemplarily shows three phases of food treatment over time. The first phase is a cooking phase followed by a holding phase and finally a consumption phase. The graph of FIG. 1 shows two exemplary treatments of temperature and humidity which may be applied to food between the cooking phase and the consumption phase. It will be recognized that other forms of treatment may be applied to food as well. The graph of FIG. 1 shows that food is often cooked at a high temperature and may be at a medium humidity. When the food is done cooking and is being held, exemplarily as in traditional food holding solutions, the food may be held in a lower temperature that at which the food was cooked while the food is also held at a higher humidity than at which the food was cooked. Finally, it has been recognized that the optimal conditions for food holding and preservation may be a different set of qualities than makes the food optimal for consumption. Exemplarily, the treatment profile changes just prior to delivery of food to the customers for consumption exemplarily to provide an increased temperature and a decreased humidity surrounding the food. This consumption phase of the treatment is not available in current food holding solutions. One challenge to the implementation of a treatment profile as exemplarily shown in FIG. 1, is deciding when to transition from the holding phase to the consumption phase. In an embodiment, this can be controlled automatedly by the holding system by reliance upon an estimation of the food delivery time. In embodiments, this estimation is provided based upon the determined location of the holding device.

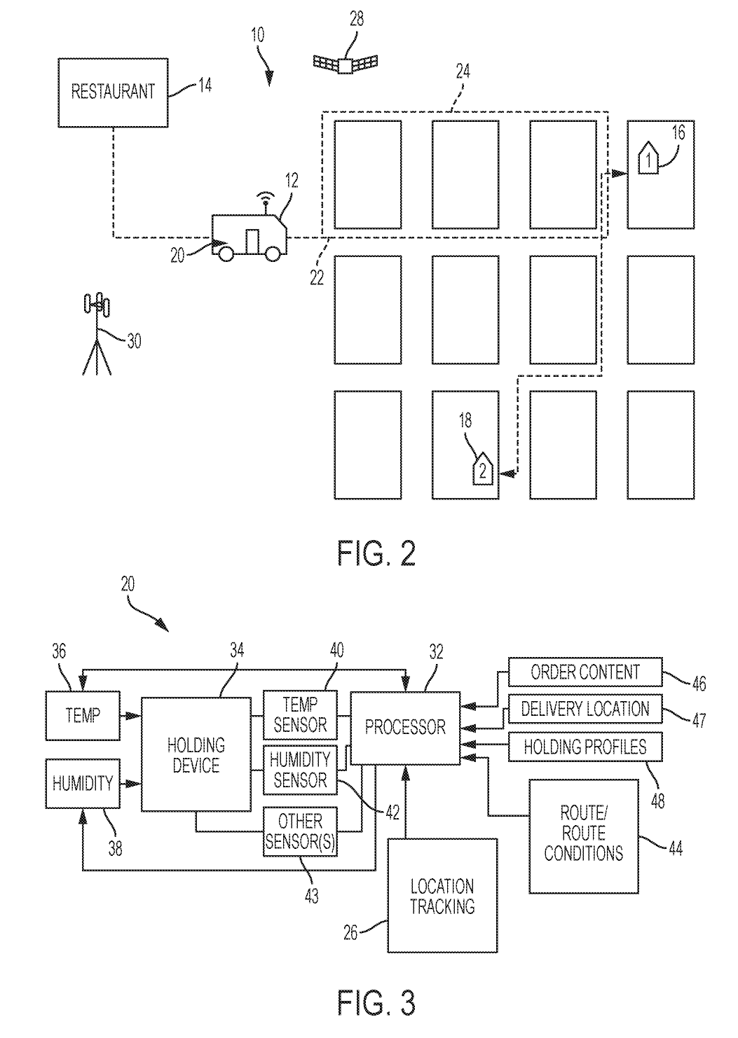

FIG. 2 depicts an exemplary embodiment of an environmental view 10 of a food delivery vehicle 12 which may transport food from a restaurant 14 to one or more of a plurality of delivery locations, for example a first delivery location 16 and a second delivery location 18. As will be described in further detail herein, the vehicle 12 includes a location based holding system 20, which is exemplarily described in further detail with respect to FIG. 3. An estimated time of arrival or time of delivery may be continuously calculated for the delivery vehicle which includes the holding system 20 in which the orders of cooked food are held before delivery. In an exemplary embodiment, the estimated time of delivery may be calculated based in part on one or more of the distance to a delivery location, the traffic conditions of a preferred route to the delivery location, estimated speeds along the preferred route, current location of the delivery vehicle relative to the delivery locations as well as delivery personnel skill, and/or estimated duration of delivery events, particularly when multiple deliveries are made before returning to the restaurant for more cooked food. In the example depicted in FIG. 2, the delivery vehicle may first deliver food to delivery location 16. The vehicle 12 may exemplarily take a first delivery path 22 or an optional second delivery path 24. After delivery to the first delivery location 16, the vehicle 12 can be navigated to the second delivery location 18 to deliver the second order of food.

As will be described in further detail herein, the holding system 20 includes a location tracking device 26 (FIG. 3). In non-limiting embodiments, the location tracking device 26 interacts with a device or system external to the holding system 20. The location tracking device 26 is capable of ascertaining the physical location of the holding system 20 which is exemplarily carried by the food delivery vehicle 12. For example, the location tracking device 26 may in some embodiments interact with a global positioning system (GPS) that communicates with satellites 28, a long range navigation system (LORAN), a cell tower based system that communicates with cell towers 30, or any other system capable of determining the physical location of the holding system 20 and/or the food delivery vehicle 12.

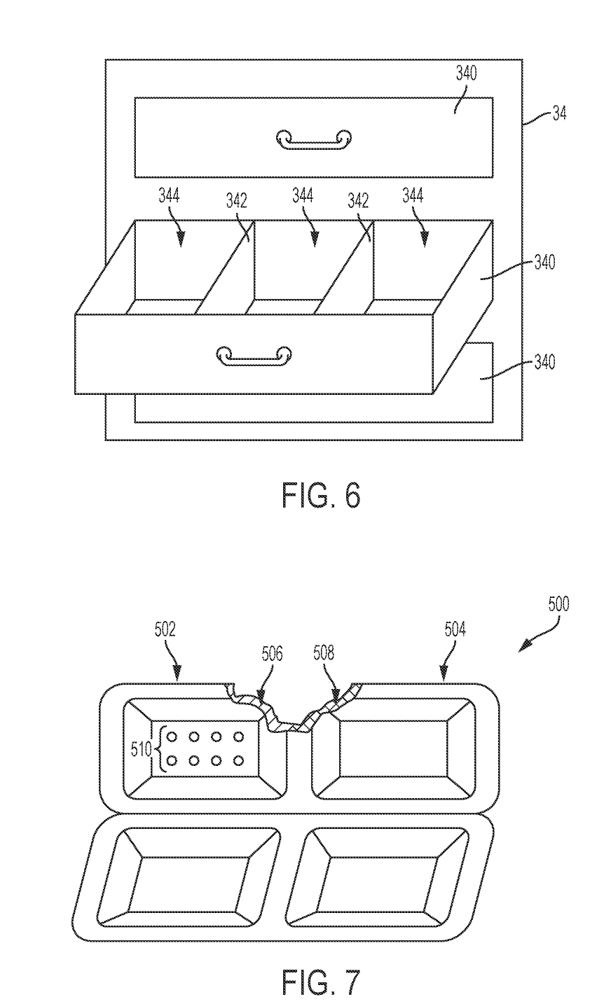

FIG. 3 is a system diagram that depicts an exemplary embodiment of a location based holding system 20. The system 20 includes a processor 32 and a holding device 24. The processor 32 operates in the manner as disclosed herein to exemplarily control a temperature or humidity within the holding device 34 within which the cooked food is stored. Exemplary embodiments of manners in which the cooked food may be stored within the holding device are described in further detail herein with respect to FIGS. 6 and 7. While temperature and humidity of the holding device are depicted as being controlled herein, it will be understood that other types of food treatment may be controlled as well. In embodiments, the temperature may be controlled by a temperature control device 36 which may exemplarily be heating elements, heated forced air, infra-red radiation, or other known food heating solutions. A humidity control device 38 operates to control the humidity. This may exemplarily include increasing or decreasing the humidity within an area defined in the holding device, exemplarily within a compartment or bin as described in further detail herein. The humidity may further be controlled with reference to a humidistat or other humidity sensor connected therein.

In embodiments of the location based holding system 20, a temperature sensor 40 and a humidity sensor 42 are connected to both the holding device 34 and the processor 32. The temperature sensor 40 and the humidity sensor 42 operate to respectively monitor the temperature and humidity within the holding device 34 and provide indications of those to the processor 32. The processor 32 uses this temperature and/or humidity information in a feedback loop to control the temperature control device 36 and/or the humidity control device 38 to achieve a target condition. The target condition may be defined according to a treatment profile.

In still further embodiments, additional sensors 43 as may be used in food holding application may be used in connection with the food holding device 34 to provide additional information to the processor 32 for use in controlling the environment within the holding device 34. One exemplary embodiment of an additional sensor 43 is a scale which provides information regarding the weight of the good in the holding device 34. Another exemplary embodiment of an additional sensor 43 is an electronic nose device that measures, tests, and/or monitors chemical composition in the headspace of the holding device 34 about the food held therein. From the sensed chemical composition, electronic nose sensors can detect food decomposition products (e.g. Sulphur, amines, aldehydes, ethanol, ethylene, metal oxides, etc. by chromatography, mass spectrometers, and/or olfactometry) to determine the freshness of the food item stored within the holding device 34. The processor 32 may use this information to adjust a holding profile or to adjust a delivery order to remedy or mitigate degradation of food quality.

As mentioned above, the processor 32 operates with a location tracking device 26 to track a location of the location based holding system 20, exemplarily within the delivery vehicle 12. The location tracking device 26 may employ GPS or wireless/cellular signal triangulation or other known location tracking techniques. The processor further receives or accesses route and/or route conditions 44. The route information may also be a part of a navigation system of the delivery vehicle so that the driver of the vehicle follows the projected route. This may be stored in a memory or may be received by the processor 32 from a remotely located source, exemplarily through wireless communication. From the position of the vehicle and the route and/or route conditions, the processor 32 calculates a time until delivery for each of the orders of cooked food held in the holding device. The route condition may include indicators of traffic, construction, or other sources of delay.

The processor 32 is also connected to at least one computer memory comprising information regarding the order content 46 the delivery location 47 for each order, as well as stored holding profiles 48. In an embodiment this information may exemplarily be stored together for each order, or may be stored and provided separately to processor 32 as needed by the processor 32. The processor 32 selects one or more holding profiles 48 stored on a computer readable medium for operation of the holding device 34 or different compartments or zones (as will be explained in further detail with respect to FIGS. 6 and 7) within the holding device 34 according to different holding profiles. The processor 32 selects a holding profile from the available holding profiles 48 based upon the content of the order 46 stored within the holding device or portion of the holding device 34. As described above with respect to FIG. 1, the holding profiles may include a defined temperature and/or humidity or other treatment parameter for operation of the holding device 34. When the estimated time to delivery reaches a certain predetermined amount (e.g. five minutes from delivery), the processor 32, according to the selected holding profile 48, operates the temperature control device 36 and/or the humidity control device 38 according to the values of the treatment parameters, exemplarily temperature and humidity, to change such conditions within the holding device 34 or within a zone or compartment within the holding device 34 appropriate to the food stored within that zone. In an exemplary embodiment, the processor 32, according to a retrieved holding profile 48, operates the temperature control device 36 and the humidity control device 38 to change the conditions with the holding device to transition from treatments of a holding phase to treatments of a consumption phase. In an example, the temperature treatment of the holding phase is low to prevent over cooking, while a temperature treatment of a consumption phase is high to raise the food temperature to a palatable temperature. The temperature of the previously held food is increased by the increased temperature while the humidity within the holding device is decreased in order to prevent the food from becoming too wet prior to consumption.

In an exemplary embodiment, the location based holding system 20 uses location information to calculate the time remaining until the food item is delivered and/or served to the intended consumer. When the time remaining reaches a threshold value as exemplarily defined in the holding profile, the location based holding system 20 operates to change the treatment conditions within the holding device 34. Exemplarily, the holding device 34 may be warmed, cooled, humidified, or dehydrated to impart these on the food item so that the food item reaches the consumer at or very near the time the food item reaches its optimum condition for consumption.

For example, the embodiment illustrated in FIGS. 2 and 3 may be directed to a pizza delivery operation. Initially, the pizza is cooked at the restaurant 14. In one embodiment, when the pizza is done cooking, the temperature of the pizza may be cooled or allowed to decrease to a stasis or holding temperature that is warm enough to prevent bacterial growth, but cool enough to stop the cooking process (which preserves the flavor of the food item). This may exemplarily be defined in a holding profile for the pizza. The pizza is transported within the delivery vehicle 12 to the first delivery location 16 at the stasis temperature within the holding device 34. However, because the stasis temperature is not the optimum consumption temperature, the temperature of the food item should reach the first delivery location 16 at the optimum consumption temperature for optimal consumer satisfaction. This may exemplarily be defined in the holding profile for the pizza. Often, the optimum consumption temperature is higher than the stasis temperature, and the optimum consumption temperature restarts the cooking process, which changes the flavor profile of the food item. Thus, the goal of the disclosed system is to have the food item reach the optimum consumption temperature at the same time as the consumer takes delivery of and/or is served the food item.

After the food item is cooked at the restaurant 14, the food item cools to its stasis temperature before being placed into the holding device 34 of a location based holding device 20 located on a vehicle 12. Alternatively, location based holding device 20 may operate to bring the food item down to the stasis temperature and hold it there during most of the delivery process. In an embodiment, this may occur passively by placing the food item in the location based holding device 20 at the cooking temperature, or near to the cooking temperature. The location based holding device may operate passively from the dissipating heat of the food product until the stasis temperature is reached. After the stasis temperature is reached, the location based holding device may operate to maintain the stasis temperature as described. In another embodiment, as the temperature in the location based holding device cools towards the stasis temperature the temperature control device 36 operates to slow the rate of temperature change such that undershoot or overshoot of the stasis temperature inside the location based holding device is minimized or managed. Regardless, the processor 32 may take in temperature information from the temperature sensor 40 and the processor 32 may activate the temperature control device 36 to adjust the temperature of the food holding chamber within a desired temperature range of acceptable stasis temperatures. The processor 32 may continuously or periodically receive location information from the location device 26 and the processor 32 may calculate the remaining distance and/or time to reaching the first delivery location 16.

The processor 32 may be communicatively connected to a computer memory to receive food item information such as the stasis temperature of the food item and the optimum consumption temperature of the food item Such memory may also include information regarding the power of the temperature control device 36 and the heat capacity of the food item (e.g., how much energy would be required to raise or lower the temperature of the food item by a set amount, such as one degree Fahrenheit). With this information, the processor 32 may calculate how much time is required to bring the food item from its stasis temperature to its optimum consumption temperature. This amount of time may be considered a “temporal threshold.” The processor 32 calculates that the food item will be delivered and/or served to the consumer at a time based upon information received from the location tracking device 26 and route information 44. The processor 32 may activate the temperature control device 36 to raise or lower the temperature of the holding device 34 an amount necessary to raise or lower the temperature of the food item to the optimum consumption temperature by the time that the food will be delivered according to the processor 32. Exemplarily, a pizza may have a stasis temperature of approximately 140 degrees F. and an optimum consumption temperature of 180 degrees F. The size of the pizza and the power of the temperature element may determine that, for example, 5 minutes of heat at 200 degrees F. is needed to raise the temperature of the pizza from 140 degrees F. to 180 degrees F. When the calculated time to reach the destination reaches 5 minutes, the processor 14 activates the temperature control device 36 and the pizza begins to warm within the holding device 34 and the warming period is timed to reach completion when the pizza reaches the first delivery location 16. In a further embodiment, the processor 32 may be provided with information regarding the warmup time and temperature profile as the temperature control device 36 warms to the target temperature. This may also be factored into the timing of when the temperature control device 36 is operated.

In some embodiments, the processor 32 may calculate alternate routes 22, 24 to the first delivery location 16, for example when traffic, weather, and/or road hazards impact the primary route 22 to the point where the alternate route 24 would take less time. The processor 32 may also continuously or periodically calculate the time remaining to the first delivery location 16 based on travel time updates impacted by traffic or weather so that the physical location at which the temperature control device 36 is activated may change during the delivery process so that the temperature of the food item reaches the optimum consumption temperature when the consumer takes delivery of the food item at the first delivery location 16.

In a still further embodiment, the holding device may be a self-contained mobile unit which includes the features as described above with respect to FIG. 3. One example of such a holding device may be a catering or other food delivery cart, or for example, a room service cart. Rather than tracking a location of a vehicle, the location of the warming device itself is tracked, portions of the movement of the warming device may be carried out by transport within a vehicle. A still further additional embodiment may locate a location based holding system 20 on a drone or other unmanned aerial vehicle (UAV).

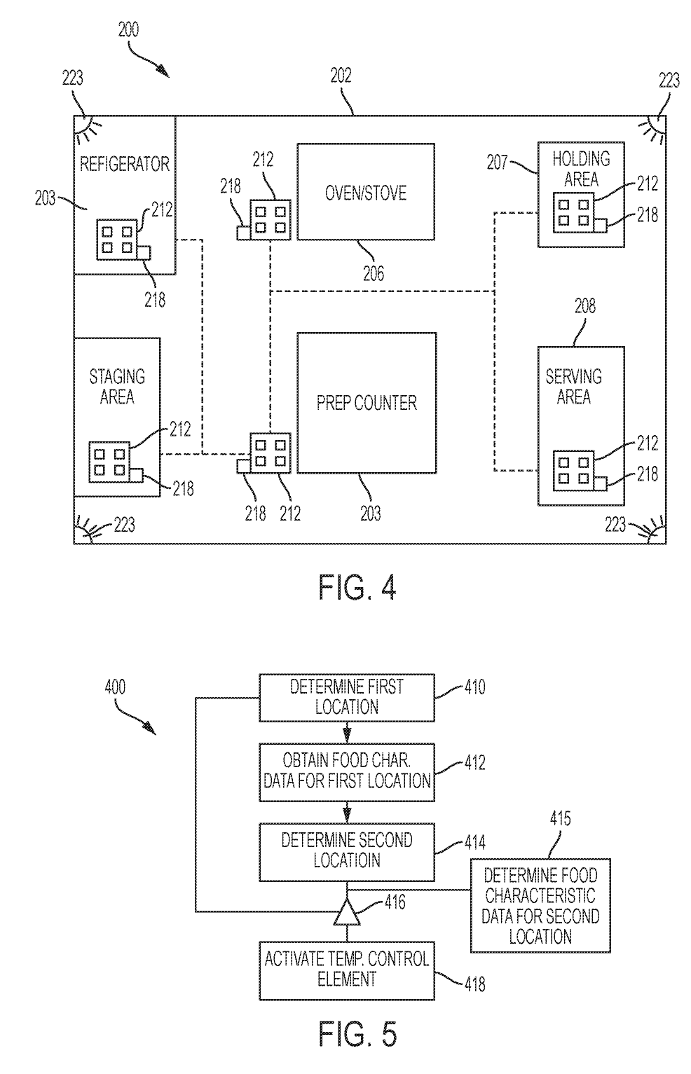

Turning now to FIG. 4, another embodiment of an environment 200 in which a location based holding system 212 may be used. The environment 200 illustrated in FIG. 4, may include a food preparation area 202, such as a kitchen of a restaurant or a kitchen of a banquet hall. An embodiment may include a plurality of location based holding devices 212. The food preparation area 202 may include several different preparation stations. For example, the food preparation area 202 may include a refrigeration/freezing area or refrigerator/freezer 203, where food is kept in a refrigerated or frozen state in storage, a staging area 204, where food is kept for a short amount of time before being prepared for service, a preparation counter or area 205, where food is prepared for cooking (such as cutting and mixing ingredients), a cooking area 206 that may include an oven or stove, a holding area 207, where cooked food is kept at a stasis temperature before being served to prolong the holding time of the food, and a service area 208, such as a delivery counter, where food is kept ready for a short time at an optimum consumption temperature for delivery to a table or for purchase by a consumer.

The location based holding device 212, may exemplarily be a food cart. The location based holding device 212 may include a location device 218. The location based holding device 212 may further include a processor, a memory, a temperature sensor, and a temperature element, these features are not shown in FIG. 4 but are shown and described above with respect to FIG. 3. The location device 218 may use a room-based location system that includes a plurality of locating devices 223 that may send and/or radio or infrared signals that may be used in the combination with the location device 218 to determine its position in the food preparation area 202. Alternatively, the location device may comprise a GPS or a LORAN, as discussed with respect to FIG. 1 above.

Each food preparation area may have a desired food temperature to optimize the food preparation process. For example, the refrigerator/freezer 203 may have a desired food temperature of between 40 degrees F. and −10 degrees F., depending on the food item, to preserve the uncooked food as long as possible. Similarly, the staging area 204 may have a desired food temperature of 50 degrees F. to 70 degrees F. to make the food preparation process more efficient, the food is only located in the staging area 204 for a short period of time, so bacterial growth should not be a problem. The food preparation counter 205, similar to the staging area 204, may have a desired food temperature of 50 degrees F. to 70 degrees F., to allow the preparer to work with the food without becoming fatigued as quickly because the preparer's hands will not be getting too cold or too hot as a result of working with the food. The cooking area 206 may have a desired temperature similar to that of the staging area 204 and the preparation area 205, or the cooking area 206 may have an elevated desired temperature to begin to pre-warm or pre-cook the food to reducing actual cooking time in the oven or stove. As discussed earlier, the holding area may have a desired temperature of 140 degrees F. to 180 degrees F. to stop the cooking process while keeping the food safe by impeding or preventing bacterial growth. These temperatures prolong the useful life of the food items in the holding area 207. The serving area 208 may have a desired temperature of 180 degrees F. or more, which may correspond to the optimum consumption temperature of the food item. In each case, the location based holding device 212 adjusts a temperature of the food holding chamber to maintain the food item(s) at the desired temperature for each food preparation area.

Turning now to FIG. 5, a logic diagram 400 is illustrated that may be stored in a memory associated with and executed by a processor as described above in one of the embodiments. The logic diagram 400 starts at step 410 with the processor determining a first location by querying the location system for a current physical location of the food storage/transportation device. The processor then searches the memory at 412 for a desired food characteristic data (e.g., either stasis temperature or optimum consumption temperature) for the first location and a food item heat capacity value (i.e., the time required to raise the temperature of the food item from the stasis temperature to the optimum consumption temperature). The processor then determines a second location at 414. The processor then determines a desired food characteristic data for the second location at 415. If the time remaining to the destination at the second location is greater than the heat capacity value at 416 (i.e., greater than the time required to heat or cool the food item to the optimum consumption temperature), then the processor returns to step 412 and determines another first location by querying the location system. In some embodiments, there may be a time delay before obtaining the second location, such as 30 seconds or 1 minute to save on data costs. If the time remaining to the destination from the second location at 414 is equal to or less than the heat capacity value at 416 (i.e., equal to or less than the time required to heat or cool the food item to the optimum consumption temperature), then the processor activates (or sends instructions to activate) the temperature controlling element at 418 to raise or lower the temperature of the food holding chamber so that the food item begins warming or cooling to the optimum consumption temperature.

FIGS. 6 and 7 depict exemplary embodiments of manners in which separate foods and/or orders maybe contained within holding devices as described herein in an effort to provide different treatment in the holding and consumption phases of the holding profile to different types of food. It may be recognized that different foods, based in part upon the preparation of the food as well as the qualities of the prepared food itself may have different holding profiles both in terms of the treatment for optimal holding, as well as the treatments for optimized consumption quality. Examples of diverse foods may exemplarily include a hamburger, pizza, chicken tenders, french fries, and pasta, although many other diverse foods may be recognized as similarly requiring a different treatment profile.

In the embodiment depicted in FIG. 6, the holding device includes a plurality of drawers 340 and each drawer 340 is associated with a single order to be delivered. In use, the delivery person opens a single drawer 340 which contains all of the cooked food for delivery. In an exemplary embodiment, each drawer 340 may be controlled according to a single holding profile based in part upon the contents of the order. In another embodiment, the drawer 340 contains partitions 342 partitioning the drawer 340 into a plurality of compartments 344 and differing food types from the order may be stored in each of the compartments 344. As an exemplary embodiment, french fries may be stored in one compartment 344 while sandwiches are stored in another compartment 344, while chicken tenders are stored in a third compartment 344. This enables the environments of each of the compartments 344 in the holding device 34 to be controlled according to a different holding profile, exemplarily to provide more humidity to chicken tenders or hamburgers while less humidity is provided to french fries. Similarly, french fries may be heated to a higher consumption temperature than sandwiches, while chicken tenders are heated more than sandwiches but less than french fries.

FIG. 7 depicts an exemplary embodiment of a product packaging 50 in a partial cut away view. The product packaging 500 depicted in FIG. 7 exemplarily contains two portions 502, 504 each portion 502, 504 configured to hold cooked food. While the packaging 500 in FIG. 7 is depicted as a unitary structure, it will be recognized that packaging may also be embodied in two different packages, each for a food item. Additionally, the packaging in FIG. 7 is depicted as clam shell packaging, while a person of ordinary skill in the art will recognize that a variety of other packaging types and styles are available and may be used. In an exemplary embodiment, two different types of food are placed in the separate portions 502, 504 of the product packaging. For example, a sandwich is placed in the left portion 502 while french fries are placed in the right portion 504. As depicted in the cut away view, the product packaging may be constructed of two different materials 506, 508 which coordinate with the holding profile applied to the compartment within which the packaged food items are placed.

In an example, the holding device operates to provide a holding profile with a comparatively low temperature and high humidity with a consumption treatment of high temperature and low humidity. The product packaging may be designed to enhance or mitigate the qualities of the treatments applied by the holding device. Exemplarily the packaging achieves this through insulation and/or venting. Exemplarily, the portion 502 of the packaging for the sandwich may include little insulation 506 and substantial venting 510 such that the conditions of the treatments provided by the holding device according to the holding profile are applied to the sandwich while the portion 504 of the packaging 500 intended for holding french fries includes substantial insulation 508 without venting to mitigate the effects of the treatments applied by the holding device according to the holding profile in a manner that results in the effective treatment profile applied to the french fries within the packaging 500 to be closer to a predetermined optimal treatment profile for the french fries. Through the use of such a product packaging 500, entire orders may be held together and receive treatments according to a single holding profile, while individual food items receive an effectively optimized treatments for that food item type.

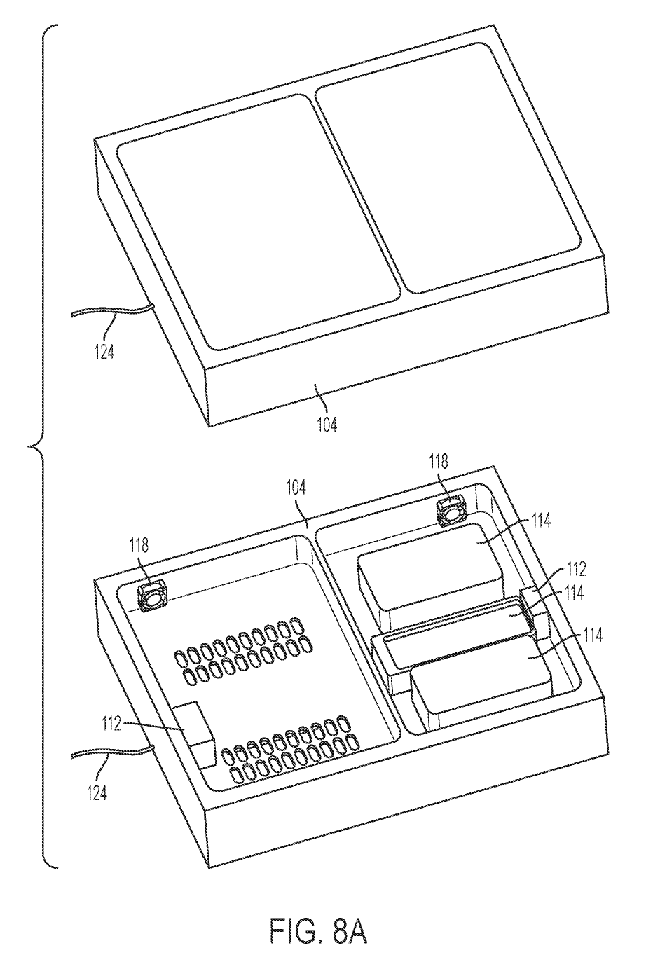

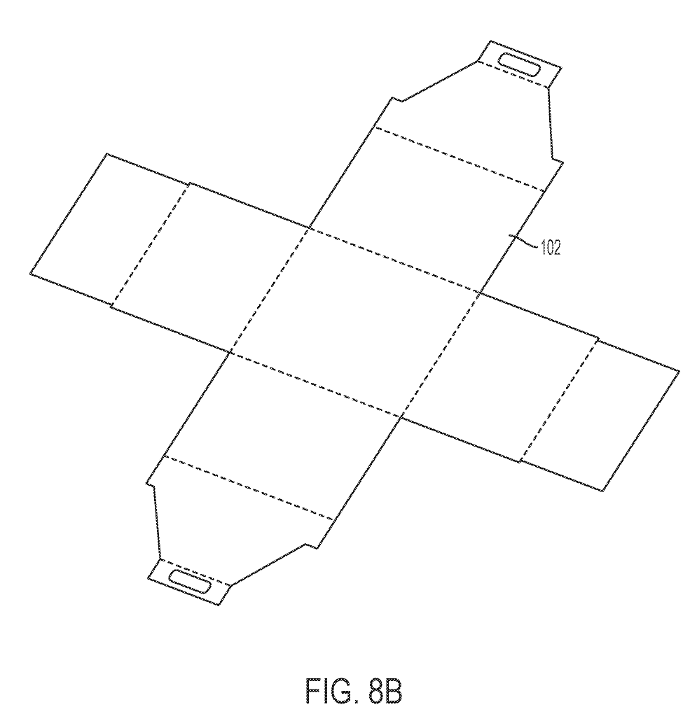

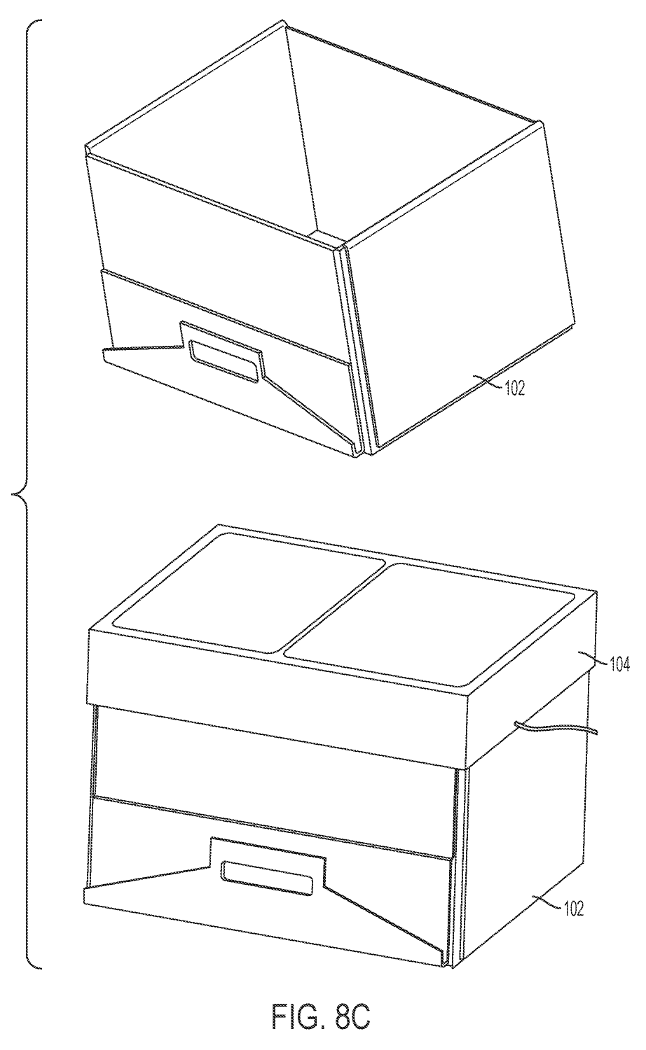

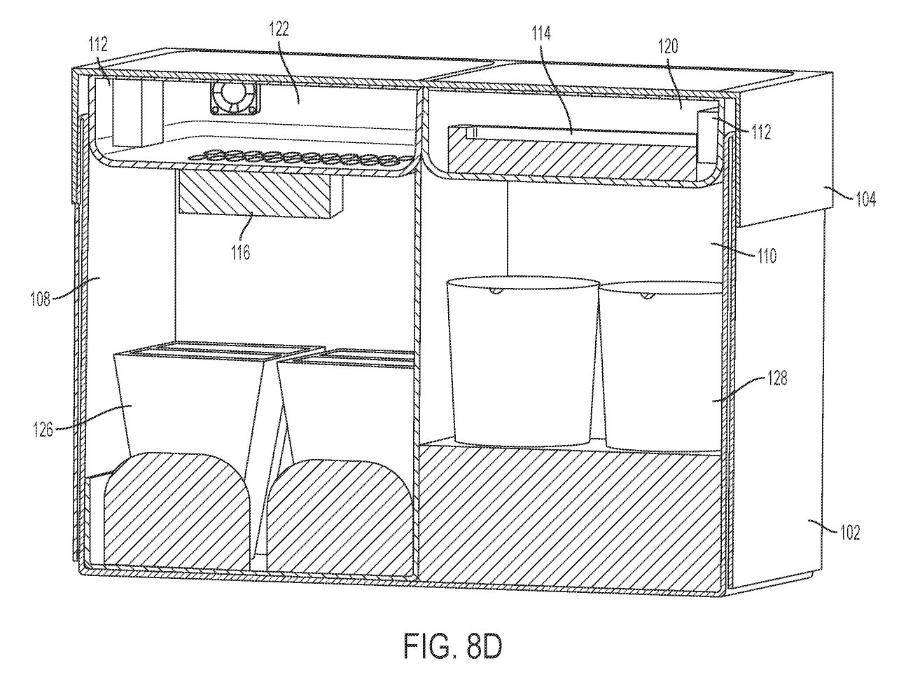

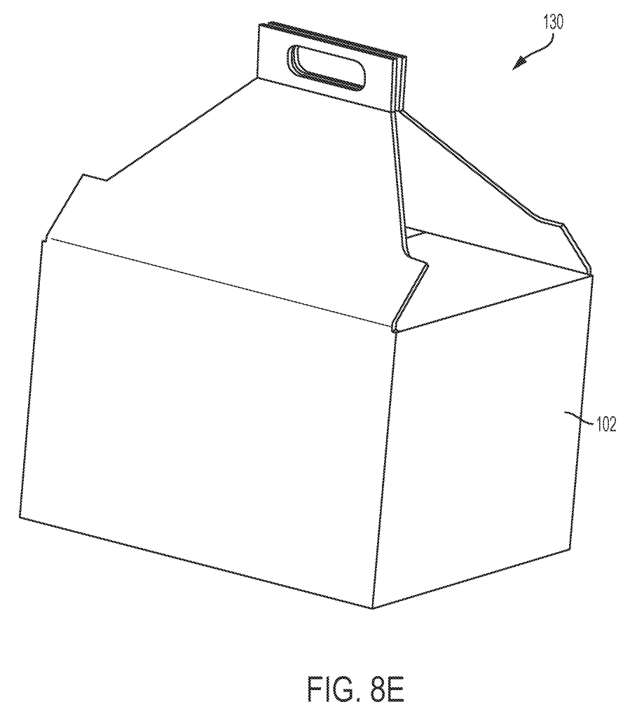

FIGS. 8A-E depict an additional exemplary embodiment of a food container and holding device. The exemplary embodiment includes two parts, shown together in FIGS. 8C and 8D and separately in FIGS. 8A, 8B, and 8E. The two parts of the embodiment include a delivery container 102 and a climate control device 104. The delivery container 102 is exemplarily constructed in a disposable manner, such as by cardboard, plastic, or a combination thereof. The delivery container may exemplarily be foldable in construction from a single cut piece of material as depicted in FIG. 8B. In a first step of use, the delivery container 102 is folded into a box as depicted in FIG. 8C. In a further embodiment, the delivery container 102 may include a divider 106 such as to divide the interior of the container 102 into a first section 108 and a second section 110. The divider 106 may be constructed to have insulative properties so that the first section 108 and the second section 110 may provide different environmental conditions (e.g. temperature and humidity). As will be described in further detail herein, the entire container, or the respective sections of the container may be used to define an area about food to be delivered, the climate characteristics of which will be controlled by operation of the climate control device 104. The climate control device 104 may exemplarily include fans 112 which are configured to distribute air about the respective sections. The climate control device 104 may include one or more heating elements 114 to increase the temperature a section or sections or a cold source 116 configured to provide a source of cooling to a section or sections of the container 112. In an exemplary embodiment, the cold source 116 may be a refrigeration system and an electrical condenser or the cold source 116 may be a reusable pack of frozen material, exemplarily a frozen gel pack.

Sensors 118 may exemplarily monitor the condition within each of the sections produced by the climate control device 114. In an exemplary embodiment, the climate control device 104 includes a heating section 120 and a cooling section 122, containing the respective components as described above. It will be recognized that these sections, or other section may further include humidifying or dehumidifying devices to further control the climate produced within one or more sections of the container 102. One or more wires 124 exemplarily provide electrical power and/or data communication to the climate control device 104. In one exemplary embodiment, the climate control device 104 includes a processor (not depicted) which operates the components as described herein while in another embodiment, the at least one wire 124 connects the climate control device 104 to a processor which receives information from at least the sensors 118 and operates to control at least one of the fans 112, heater 114, or cold source 116. Electricity to operate these devices may further be provided on the at least one wire 124.

In use, food to be delivered is loaded into containers and placed into the delivery container 102. Cold food 126 is exemplarily loaded into the first section 108 and hot food is exemplarily loaded into the second section 110. The climate control device 104 is secured over the top of the open delivery container 102 and the heating section 120 operated to keep the second section 110 containing the hot food 128 hot with a low humidity. The cooling section 122 is operated to keep the first section 108 of the delivery container 102 and the cold food 126 located therein cool. The apparatus may be operated according to heating profiles or other manners of operation as described herein in further detail until the delivery location is reached, upon delivery, the climate control device 104 is removed from the delivery container 102 and the delivery container 102 is folded up to form a final delivery package 130 exemplarily a box with a handle for final delivery to the customer. This is depicted in FIG. 8E

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A location based holding system comprising:
a holding device, the holding device including a food storage chamber, a temperature sensor that senses the temperature of the food storage chamber, and a temperature control device that changes the temperature of the food storage chamber,
a location device that determines the physical location of the holding device,
a memory that stores information about a food item located in the food storage chamber, and
a processor operatively coupled to the memory, to the location device, and to the holding device, the processor activating the temperature control device of the holding device based on the physical location of the food storage or transportation device.

2. The location based holding system of claim 1, wherein the memory includes a mapping routine and a map database, the processor calculating a route from an origin to a destination using the mapping routine and the map database.

3. The location based holding system of claim 2, wherein the processor calculates time remaining to the destination.

4. The location based holding system of claim 3, wherein the information stored in the memory includes a heat capacity value for the food item stored in the food holding chamber and the processor uses the heat capacity value to calculate a time remaining to the destination at which the temperature of the food holding chamber must be changed to cause the food item in the food holding chamber to reach an optimum consumption temperature at or at the same time as reaching the destination.

5. The location based holding system of claim 3, wherein the information stored in the memory includes a holding profile for the food item stored in the food holding chamber and the processor operates the temperature control device according to the holding profile and the time remaining to the destination.

6. The location based holding system of claim 1, wherein the processor, the memory, and the location system are part of a mobile computing device that is communicatively connected to the food storage or transportation device.

7. The location based holding system of claim 1, wherein the location device is part of a global positioning system (GPS).

8. The location based holding system of claim 1, wherein the temperature controlling element is a heating element.

9. The location based holding system of claim 1, wherein the food storage or delivery device includes a plurality of food holding chambers.

10. The location based holding system of claim 1, further comprising a humidity sensor and a humidification device.

11. The location based holding system of claim 1, further comprising an electronic nose sensor that detects food decomposition chemicals in a headspace within the holding device.

12. A method of holding prepared food compromising:
receiving cooked food within a compartment of a holding device;
operating the holding device to apply a first treatment comprising at least one of a first temperature and a first humidity, the treatment being temporally applied according to a holding profile;
receiving a value indicative of a time until delivery of the prepared food;
monitoring the received value against the holding profile where upon a predetermined time until delivery, the holding profile changes from a holding phase to a consumption phase; and
operating the holding device to apply a second treatment according to the holding profile, the second treatment including at least one of a second temperature and a second humidity.

13. The method of claim 12, further comprising selecting the holding profile from a plurality of holding profiles based upon an identification of the cooked food.

14. The method of claim 12 wherein the holding device is located within a delivery vehicle and further comprising:
tracking a location of the delivery vehicle receiving an indication of a delivery location;
calculating an estimated time until delivery based at least upon the vehicle location and the delivery location; and
using the calculated estimated time until delivery as the received time indicative of the time until delivery of the prepared food.

15. The method of claim 12, further comprising:
receiving an indication of a food type of the cooked food received in the compartment of the holding device; and
selecting the holding profile from a plurality of holding profiles based upon the indication of the food type.

16. A location based holding system comprising:
a holding device including a temperature sensor that senses a temperature about the holding device and a temperature control device operable to change a temperature of the holding device;
a food container operable to receive a cooked food to be held by the holding device;
a location device that determines the physical location of the holding device,
a memory that stores information about a food item located in the food container, and
a processor operatively coupled to the memory, to the location device, and to the holding device, the processor activates the temperature control device of the holding device based on the physical location of the holding device.

17. The location based holding system of claim 16, wherein the food container is a food storage chamber integral to the holding device and the temperature control device operates to change the temperature within the food storage chamber.

18. The location based holding system of claim 16, further comprising a food storage chamber integral to the holding device, and the food container is placed within the food storage chamber.

19. The location based holding system of claim 16, wherein the holding device is removably connected to the food container, wherein when the holding device is connected to the food container, the holding device operates to change a temperature of the food container.

20. The location based holding system of claim 19, wherein the food container comprises a first chamber and a second chamber and the temperature control device of the holding device is a first temperature control device, the holding device comprising a second temperature control device; and
wherein when the holding device is connected to the food container, the first temperature control device operates to control the temperature of the first chamber according to a first holding profile and the second temperature control device operates to control the temperature of the second chamber according to a second holding profile.
